(19) United States
(12) Patent Application Publication
(10) Pub. No.: US 2007/0267340 A1
(43) Pub. Date: Nov. 22, 2007

(54) HYDROFOIL-SHAPED SUCTION STRAINER WITH AN INTERNAL CORE TUBE

(76) Inventors: James M. Bleigh, Olathe, KS (US); Gordon H. Hart, Shrewsbury, MA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/751,297

(22) Filed: May 21, 2007

Related U.S. Application Data
(60) Provisional application No. 60/802,440, filed on May 22, 2006.

(51) Int. Cl. B01D 39/00

(52) U.S. Cl. 210/486

(57) ABSTRACT

A suction strainer is provided for use in a pumping system of the type wherein a suction line provides fluid flow to a pump and wherein the suction strainer is connected to the suction line for removing solids or aquatic life from a flow of fluid being drawn into the suction line, The suction strainer comprises a hydrofoil and an internal conduit. The hydrofoil is formed with opposed filtering surfaces having apertures formed for the passage of fluid to an internal volume. The internal conduit is formed with a surface extending the length of the conduit and having apertures formed for the passage of fluid from the internal volume of the hydrofoil to the internal volume of the conduit.

### CROSS-REFERENCE TO RELATED APPLICATION

This application claims the benefit of U.S. Provisional Application No. 60/802,440, filed May 22, 2006, which is incorporated by reference herein in its entirety.

### FIELD OF THE INVENTION

The present invention relates generally to water intake suction strainers for pumping systems, and, more particularly, to a hydrofoil-shaped suction strainer having an internal core strainer tube.

### BACKGROUND OF THE INVENTION

Suction strainers are employed in various pump applications to prevent debris or other undesirable solid matter from being drawn into the pump suction. Such applications range from simple well water pump strainers to highly industrial, high capacity (head) pumps. Depending upon the particular application, if such debris or solid matter enters the pump suction, degradation of pump performance and possible damage to the pump itself are likely. In some applications, the effectiveness of the suction strainer has significant safety importance. For example, in nuclear power plants, unhampered performance is essential.

U.S. Pat. Nos. 5,696,801, 5,843,314, 5,935,439, 5,958,234, and 6,491,818, which are incorporated herein in their entirety by this reference, are directed to suction strainers having internal core tubes to provide suction water flow control. These strainer designs attempt to reduce localized high suction entrance velocities to prevent debris from impinging and lodging on the strainer and to reduce turbulent inlet flow to the pump suction, either of which could severely degrade pump performance. In particular, these strainers have been used in conjunction with emergency core cooling pumps at nuclear power plants.

With the recent release by the United States Environmental Protection Agency (EPA) of Rule 316(b) of the Clean Water Act, industrial facilities, such as power plants, which typically use more than 50 million gallons per day of cooling water, must ensure that their cooling or recirculation fresh water intakes protect early life stages of fish that live in that water. The Rule requires that protective features employ the “Best Available Technology.” The EPA has identified several different solutions, one of which provides for passive, cylindrical, wedgewire screens to replace existing conventional intake screens. While these passive systems are somewhat effective across a short axial length, their designs tend to create eddies that can after the flow across adjacent screens that are installed in an array.

### SUMMARY OF THE INVENTION

One aspect of the present invention generally relates to a hydrofoil-shaped suction strainer that solves both of the problems of non-uniform approach velocities over the strainer's surface, and of flow-altering eddies. It has been found that non-cylindrically shaped screens will reduce the effect of eddies in adjacent arrays and will provide a more laminar flow path across the screen in stream currents than cylindrical screens. And, with end supports, the axial length of hydrofoil type screens are not limited in length as are cylindrical wedge wire screens.

At the same time, this suction strainer effectively prevents the early life stages of fish from entering the suction water intake by providing sufficiently small openings, or apertures, in the screening materials. In particular, the suction strainer may be constructed as a symmetrical hydrofoil with a blunt leading edge, a tapered trailing edge, and an internal conduit. Thus, the strainer has the advantages of the passive, wedgewire screens without the inherent disadvantages. Furthermore, with its streamlined, hydrofoil shape, the suction strainer will experience less drag from passing water.

In one embodiment, the water intake suction strainer of the present invention is designed to be placed in a body of water, with or without a natural current, and: (1) ensure substantially uniform water flow and low water velocities over all its filtering surfaces; (2) produce minimum downstream water eddies that might act on downstream screens in the array; and, (3) minimize both entrainment and impingement of early life stages of fish, such as eggs, larvae, and very young fish. In particular, in one embodiment, the internal conduit comprises a core tube that controls water flow rates through the suction strainer.

The filtering surfaces of the strainer (both of the hydrofoil and the internal conduit) may be made of perforated metal plates or sheets, metal wire screens, woven screening, etc. Internal structural ribs and stiffeners are provided as required.

Another aspect of the present invention is directed to a hydrofoil-shaped suction strainer that is designed to create a flow across the screen surface in stagnant water conditions by rotating the cantilevered hydrofoil through the water slowly from an end axis/support connected to the intake system and driven by mechanical means to spin the hydrofoil through the body of water so that it performs the same effective function even when water flows from an alternate or opposite direction, as would be the case in tidal water applications.

### BRIEF DESCRIPTION OF THE DRAWINGS

FIG. 1 is a schematic representation of portions of a plant cooling system illustrating the installation of a suction strainer of the present invention.

FIG. 2 is a perspective view of one embodiment of the suction strainer of the present invention; and

FIG. 3 is a side elevational view of the suction strainer of the embodiment of FIG. 2.

### DETAILED DESCRIPTION OF THE PREFERRED EMBODIMENTS

Certain exemplary embodiments of the present invention are described below and illustrated in the attached Figures. The embodiments described are only for purposes of illustrating the present invention and should not be interpreted as limiting the scope of the invention. Other embodiments of the invention, and certain modifications and improvements of the described embodiments, will occur to those skilled in the art, and all such alternate embodiments, modifications and improvements are within the scope of the present invention.

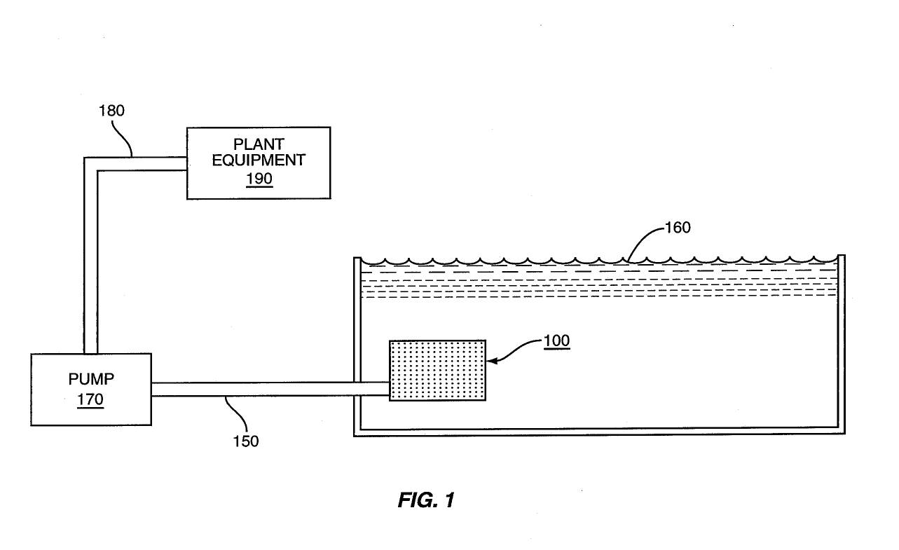

As shown in the schematic of FIG. 1, a typical plant cooling system, as might be found in a nuclear power plant, comprises a water suction line 150 which draws water from a cooling source 160 such as a lake. The water is drawn through the suction line 150 by a pump 170 which then pumps the water under pressure downstream through one or more discharge lines 180 to one or more components 190 that are to be water cooled. The suction strainer 100 of the present invention is installed upstream of and interconnected to the suction line within the cooling source 130.

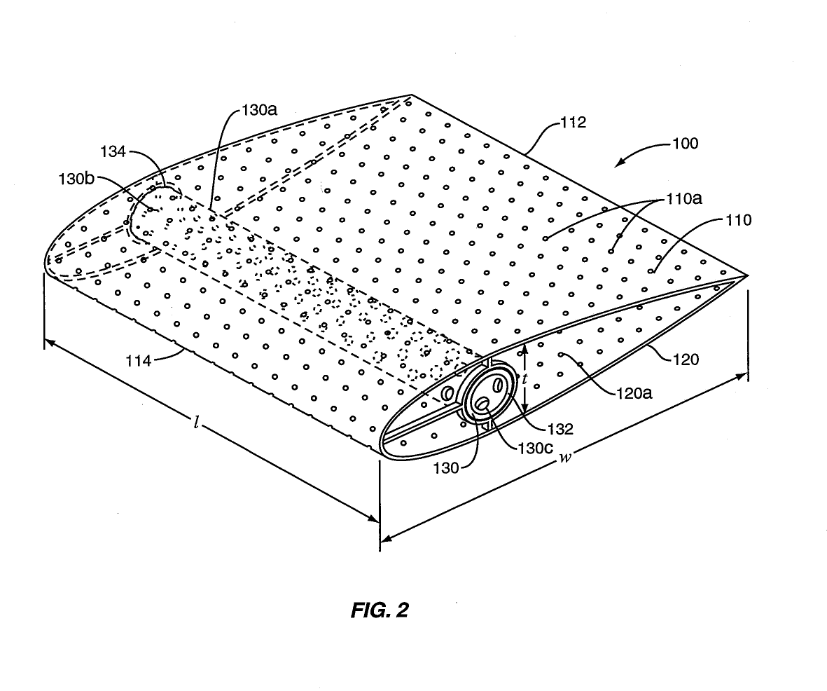

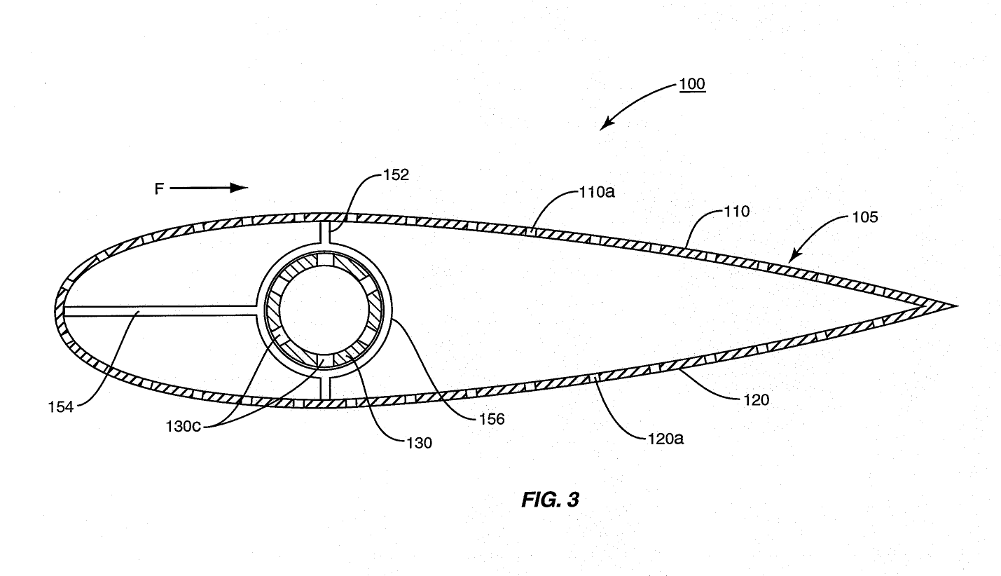

Referring now to FIGS. 2 and 3, one embodiment of the suction strainer 100 is shown having a hydrofoil shape, or geometry. The suction strainer 100 comprises a hydrofoil 105 having opposed filtering surfaces 110, 120, and an internal conduit 130. In the embodiment shown in FIG. 1, conduit 130 is an internal core tube. The hydrofoil 105 configuration shown in FIG. 1 further comprises a blunt, hydrodynamic leading edge 114 and a tapered trailing edge 112. This unique strainer thus has the shape of a symmetrical hydrofoil (i.e., the hydrofoil shape has an equal distance between the chord line and each filtering surface 110, 120) The chord line is shown in FIG. 1 as w. The maximum height of the hydrofoil 105 is shown as dimension t. The width, l, of the hydrofoil 105 (the dimension that is substantially parallel to the axis of the internal core tube 130) is dependent on the total surface area of the hydrofoil that is necessary to keep the total water flow through the screening surface below about 0.5 feet per second into the screen, shown as F.

The core tube 130 is generally located in the thickest part of the hydrofoil, with its axis running substantially parallel to the length of the hydrofoil. This is best shown in FIG. 3. The core tube 130 comprises an upstream end 132 and a downstream end 134. In one embodiment, the ends 132, 134 may be affixed to the corresponding ends of the hydrofoil 105. Alternatively, as described below, the hydrofoil 105 may be mounted to rotate about one end of the hydrofoil 105. The core tube 130 also comprises a generally cylindrical surface 130c having apertures 130a, 130 b formed therethrough, as described in greater detail below. While shown in FIG. 2 as 130a and 130b, the apertures may comprise a plurality of different areas and are not limited to two specific ones.

As best shown in FIG. 2, the filtering surfaces 110, 120 of the hydrofoil may be constructed from a porous material, such as perforated metal plates or sheets, wire mesh, screening materials, etc. having a preselected pattern of apertures 110a and 120a formed through the surfaces 110, 120 to permit the passage of water through the surfaces 110 and 120 and into the internal volume of the hydrofoil 105. In one embodiment, the apertures 110a and 120a are similarly dimensioned. The dimensions of the apertures are dependent upon the particular application and installation for which the suction strainer 100 is intended. For example, in many power plant cooling systems, the apertures in the hydrofoil are circular and may range from about 0.5 millimeters to about 3.0 millimeters in diameter. Alternatively, the apertures may comprise other shapes, such as squares.

After passing through the apertures 110a, 120b in the filtering surfaces 110, 120, the water enters the core tube 130 via the apertures in 130, such as 130b and 130c. The holes 130b, 130c are formed in one or more preselected patterns to provide for uniform water flow rates, and hence, will force uniform approach velocities axially at the filtering surfaces surrounding the core tube 130. To create uniform flow axially along the filtering surface, the holes in the core tube will increase in size towards the upstream end 132 of flow. As shown in FIG. 2, the apertures 130b at the downstream end 134 are smaller in area than the apertures 130c at the upstream end 132. As will be appreciated, the apertures may comprise a plurality of different areas between the downstream end 134 and the upstream end 132.

The suction strainer may be structurally reinforced from the inside, or outside, depending upon the thickness of the filtering surfaces 110, 120, and the form of support needed for the core tube 130. Such reinforcement may be in the form of one or more structural members 152, 154, although numerous structural support arrangements are possible and well known in the structural arts. The configuration shown in FIG. 2 is thus merely exemplary. As shown, the internal core tube 130 accepts structural bearing loads and support from the structural support members 152, 154.

Another aspect of the present invention is a hydrofoil-shaped suction strainer wherein the hydrofoil is mounted to rotate about one end of the internal conduit, or core tube 130. As shown in FIG. 3, in one embodiment this may be accomplished by configuring the structural support members 152, 154 so that they connect to one or more rotating collars 156 so that the hydrofoil may rotate freely about one end of the internal core tube 130. In this manner, the suction strainer 100 also may be installed and used in applications in which the direction of suction flow varies, such as in tidal water applications.

Although the present invention has been described with respect to particular embodiments, it is to be understood that modifications and variations may be utilized without departing from the spirit and scope of the invention, as those skilled in the art will readily understand. Such modifications and variations are considered to be within the purview and scope of the invention. For example, the suction strainer also could be shaped with the same leading edge configuration at opposite edges of the hydrofoil so as to be effective in tidal streams that will cause the flow stream to occur each day in opposite directions.

We claim:

1. A suction strainer for use in a pumping system of the type wherein a suction line provides fluid flow to a pump and wherein the suction strainer is connected to the suction line for removing solids and aquatic life from a flow of fluid being drawn into the suction line, the suction strainer comprising:
(a) a hydrofoil, comprising:
(i) a leading edge and a trailing edge defining a width therebetween;
(ii) opposed filtering surfaces extending between the leading edge and the trailing edge, the opposed filtering surfaces defining an internal volume;
(iii) a plurality of apertures formed through the opposed filtering surfaces for the passage of fluid therethrough to the internal volume;
(b) an internal conduit positioned within the internal volume, the internal conduit comprising:
(i) a first end and a second end defining a length therebetween, the second end configured for attachment to the suction line;
(ii) the length extending substantially parallel to the length of the hydrofoil;
(iii) a surface extending the length of the conduit and defining an internal volume; and
(iv) a plurality of apertures formed through the surface for the passage of fluid from the internal volume of the hydrofoil to the internal volume of the internal conduit.

2. The suction strainer of claim 1 wherein the hydrofoil is symmetrical about a chord line extending between the leading edge and the trailing edge of the hydrofoil.

3. The suction strainer of claim 1 wherein the plurality of apertures in the opposed filtering surfaces have similar areas.

4. The suction strainer of claim 3 wherein the apertures are substantially circular in cross-section, each aperture having a dimension between about 0.5 millimeters and 3.0 millimeters in diameter.

5. The suction strainer of claim 3 wherein the apertures are substantially square.

6. The suction strainer of claim 1 wherein the internal conduit is tubular.

7. The suction strainer of claim 1 wherein the plurality of apertures formed in the surface of the internal conduit have varying areas.

8. The suction strainer of claim 7 wherein the areas of the apertures in the surface of the internal conduit increase toward the first end of the internal conduit such that the flow of liquid through the opposed filtering surfaces is uniform.

9. The suction strainer of claim 1 wherein the hydrofoil is mounted to rotate about the second end of the internal conduit wherein the leading edge of the hydrofoil is movable with respect to the flow of fluid about the filtering surfaces of the hydrofoil.
